(19) United States
(12) Patent Application Publication
(10) Pub. No.: US 2010/0127856 A1
(43) Pub. Date: May 27, 2010

(54) Flash drive locator

(76) Inventor: Michael Brian Sipple, Tustin, CA (US)

Correspondence Address: Michael Bell, 2931 Hickory Place, Fullerton, CA, 92835, US

(21) Appl. No.: 12/313,859

(22) Filed: Nov. 25, 2008

(51) Int. Cl. G08B 21/00

(52) U.S. Cl. 340/540

(57) ABSTRACT

A memory locating device includes flash memory and remote locating components in a common housing. The device signals its presence in response to an external signal. One embodiment comprises a USB connector coupled to flash memory; a signal receiver capable of generating an output in response to an external signal; a power source electrically coupled to the USB connector and to the signal receiver; an annunciator coupled to the signal receiver and capable of signaling the presence of the device in response to the output; and a housing encompassing each of the other components.

### BACKGROUND OF THE INVENTION

1. Field of the Invention

This invention concerns the field of misplaced object location. In particular, the objects are USB flash drives, variously known as thumb drives, pen drives, pocket drives, memory sticks, etc.

2. Background art

In recent years Universal Serial Bus (“USB”) flash drives have become a common form of portable data storage. Their compact size, increasing capacity, durability, and decreasing cost make them attractive means of storing personal data. Some of the features of USB flash drives that make them attractive create a vulnerability. Their small size makes them easy to carry but also easy to lose. Their large capacity means that, if lost, a great deal of data may become unavailable or may have its security compromised.

A number of methods have been proposed to reduce the likelihood of loss of flash drives. For example, many commercial flash drives have points of attachment for lanyards permitting the flash drive to be worn around the neck or attached to a key chain.

Various security systems reduce the risk that data may be compromised. Password access is common. Other methods, exemplified by U.S. Pat. No. 6,983,888 and US patent applications 2006/0036872 A1 and 2003/0005337 A1, seek to disable a flash drive when used by one not authorized. These methods do not help to recover a lost device.

If lost, a flash drive may be located by conventional search, but this is time consuming and frequently unsuccessful.

U.S. patent application 2007/0271348 describes a method of locating a flash drive when the flash drive is used by another. A software agent loaded on the flash drive causes an unauthorized connected computer to send an email message including the identifying IP address to the owner of the flash drive.

U.S. patent application Ser. No. 12/156,526 filed Jun. 2, 2008, which is hereby incorporated by reference in its entirety, discloses my invention for an object locator system.

U.S. Pat. No. 5,680,105 discloses an object locator system with a collection of activation units and a collection of response units, where each response unit may be adhered to an object to be located. Activation units and response units are associated in pairs with each member of the pair sharing an identifying code. The activation unit contains a radio frequency (“RF”) transmitter which communicates with an RF receiver in a response unit. In use, an operator triggers the activation unit to emit an encoded RF signal, and the associated response unit receives the signal and responds by producing a sound. The operator then tracks the sound to locate the misplaced object.

U.S. Pat. No. 6,366,202 discloses a bidirectional system that differs in some regards from the above, but shares its limitations. Here, the activation unit and receiver unit are substantially identical. They communicate using acoustic transceivers rather than RF, and each unit is capable of performing either the activation or the response unit function.

### SUMMARY OF THE INVENTION

The below-described embodiments illustrate various adaptations of the invention. From the description of these embodiments, other aspects of the invention can be readily fashioned by making slight adjustments or modifications to the components and steps discussed below.

Unless otherwise defined, all technical terms used herein have the same meaning as commonly understood by one of ordinary skill in the art to which this invention belongs. Where definitions conflict between this document and others in documents incorporated by reference, the definitions in this document shall control.

The expression disposed within as used herein with reference to a housing means that at least a portion of the component mentioned is within the housing. It includes components with a portion protruding from the housing and components attached to the housing.

One embodiment of the invention is a flash memory drive that includes components permitting its recovery when lost or misplaced. A second embodiment is a locator unit configured to be attached to a flash drive through the flash drive's USB port to create a flash drive-locator device assembly. When attached to a flash drive, this embodiment permits the recovery of the assembly when lost or misplaced.

In some embodiments, the memory locating device includes both flash memory and a locating device in a common housing. The locating device signals its presence in response to an external signal. One embodiment comprises a housing, a USB connector disposed within the housing; a flash memory drive disposed within the housing and electrically coupled to the USB connector; a signal receiver disposed within the housing and capable of generating an output in response to the external signal; a power source disposed within the housing electrically coupled to the USB connector and to the signal receiver; and an annunciator coupled to the signal receiver and capable of signaling the position in response to the output.

In some embodiments, the locating memory device further comprises a control disposed within the housing and a transmitter operatively connected to the control and configured to transmit a countersignal in response to user activation of the control.

In some embodiments, the locating memory device further comprises a display disposed within the housing, operatively coupled to the signal receiver, and configured to display a message in response to the output.

Other embodiments comprise a locating device that responds to an external signal and that attaches to a flash drive through the flash drive's USB connector, including a housing; a male USB connector disposed within the housing; a female USB connector disposed within the housing and electrically coupled to the male USB connector; a signal receiver disposed within the housing and capable of generating an output in response to the external signal; a power source disposed within the housing electrically coupled to the receiver; and an annunciator coupled to the signal receiver and capable of signaling the presence in response to the output.

In some embodiments the female USB connector mates with a standard USB male connector with greater retentive force than does the male USB connector with a standard USB female connector.

In some embodiments the locator device comprises a transmitter disposed within the housing, a GPS receiver disposed within the housing and operatively connected to the transmitter and to the signal receiver, wherein the GPS receiver is configured to receive GPS signals and to calculate the position of the locating device and to encode the position as position information in response to the output and to transfer the position information to the transmitter, and wherein the transmitter is configured to transmit the position information.

### BRIEF DESCRIPTION OF THE DRAWINGS

FIG. 1 illustrates a unitized embodiment of the invention.

FIG. 2 illustrates a separable embodiment of the invention shown in relationship to a flash drive.

FIG. 3 illustrates a variety of external sources that may communicate with some embodiments of the invention.

FIG. 4 illustrates a block diagram of a unitized embodiment of the invention.

FIG. 5 illustrates a block diagram of a separable embodiment of the invention.

In the figures, like items are designated by like numerals.

### DETAILED DESCRIPTION

A first unitized embodiment 1 of the invention is a flash memory drive that includes components permitting its recovery when lost or misplaced. A second separable embodiment 20 is a locator unit configured to be attached to a flash drive through the flash drive's USB port to create a flash drive-locator device assembly. When attached to a flash drive, this embodiment permits the recovery of the assembly when lost or misplaced.

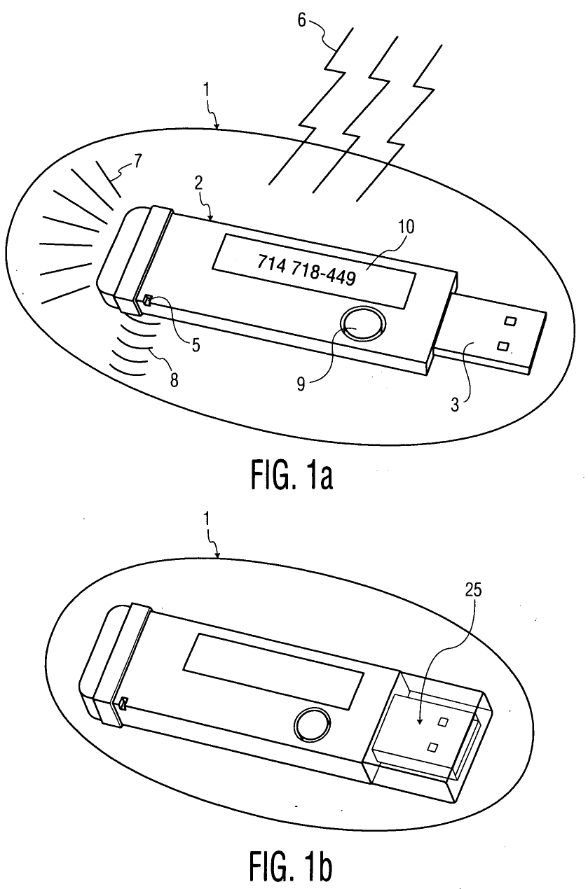

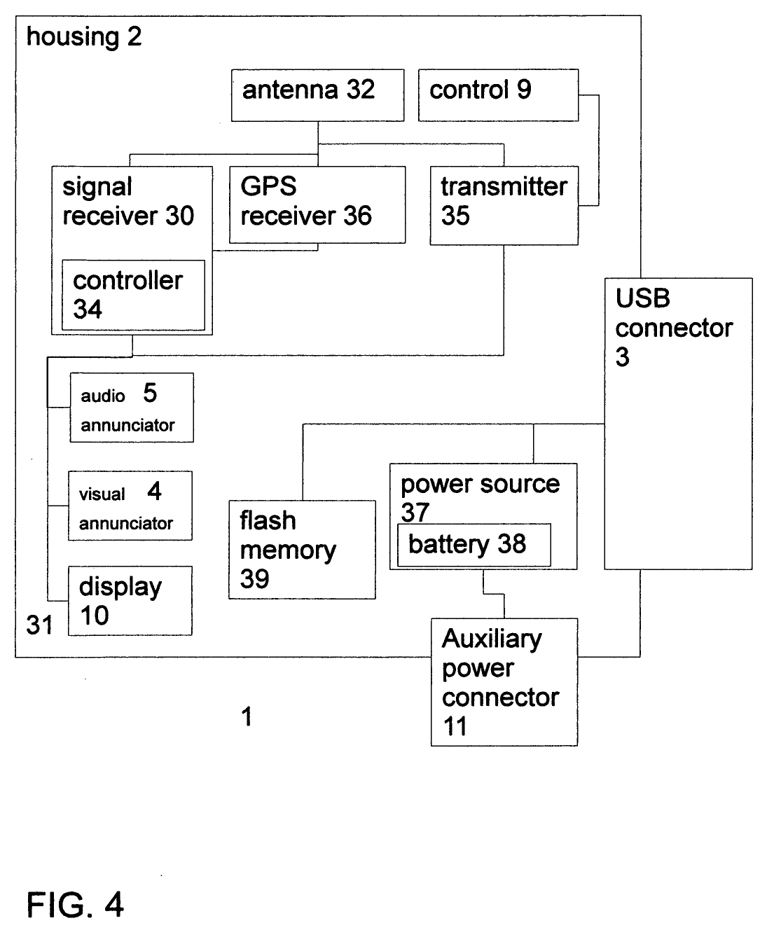

Referring to FIGS. 1 and 4, first embodiment 1 includes housing 2, commonly formed of plastic or metal. Some components of embodiment 1 are entirely contained within housing 2; others, such as USB connector 3, visual annunciator 4, audio annunciator 5, control 9, and display 10 have portions which protrude beyond the confines of the housing or are otherwise accessible to a user. Cap 25 may serve as a protective cover to USB connector 3. This is shown mated to the flash memory drive in view 1b.

The purpose of annunciators 4 and 5 is to indicate the presence of the device to aid in its recovery. Annunciators produce detectable signals, such as light 7 or sound 8 which alert the user to the presence of the device. Light 7 may be constant but is preferably pulsing or flashing so as to be more readily detectable and to preserve electrical energy. Sound 8 may be of constant intensity but is preferably modulated to be more readily detectable. Visual annunciator 4 is preferably a light source such as a light emitting diode (“LED”). The light is preferably emitted from several sides of the device to enhance visibility as by use of multiple LEDs or by use of a diffusing lens. Audio annunciator 5 is preferably an audio transducer such as a beeper, speaker, or buzzer.

Within housing 2 are USB connector 3, flash memory 39, power source 37, signal receiver 30, and at least one annunciator 4 or 5. In some embodiments, more than one annunciator, antenna 32, control 9, display 10, transmitter 35, and GPS receiver 36 may also be present.

Flash memory 39 performs the normal functions of a flash memory drive to store and retrieve information. It includes both the memory storage elements as well as any circuitry necessary to control and access the memory storage elements. Flash memory 39 is electrically connected to the conductors of USB connector 3.

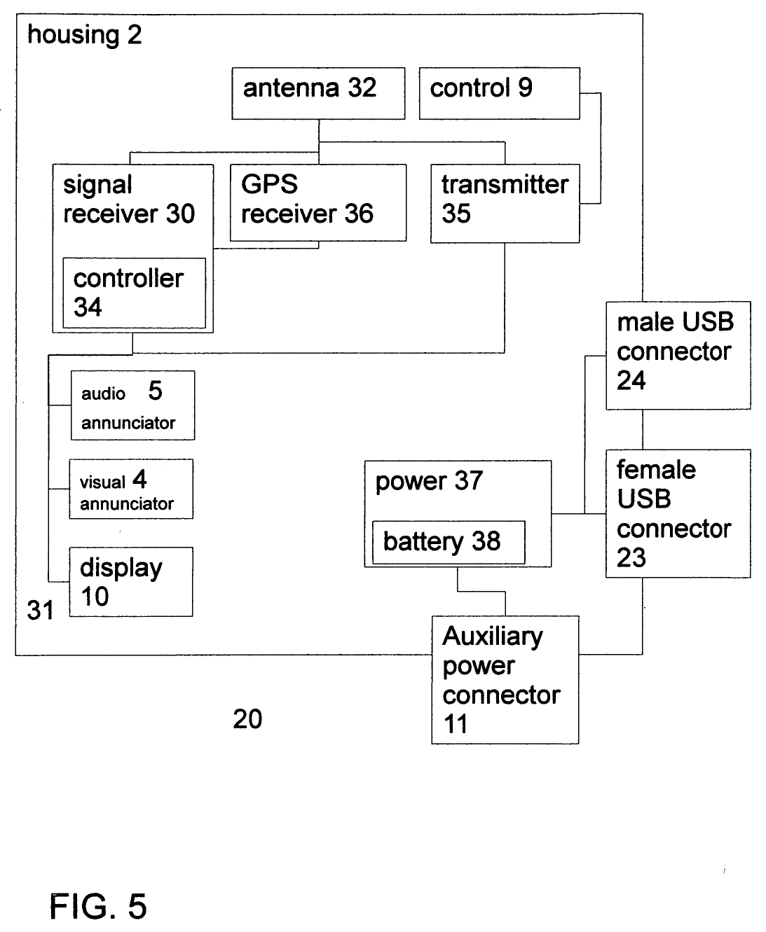

Locator components such as the signal receiver and annunciators require electrical power to operate. A flash drive does not normally include a source of power as flash memory is nonvolatile and connection to a USB port (as on a computer) supplies power during use. Electrical power source 37 supplies power for the locator function. Power source 37 includes battery 38 and associated circuitry. Although omitted from FIGS. 4 and 5 for clarity, each component requiring electrical power for locator operation is electrically connected to power source 37.

Battery 38 may be a primary cell or a rechargeable battery. In some embodiments, the locating device includes a rechargeable battery that may be charged via power supplied from the USB port. One of the functions of an active USB connection is to supply power to operate USB devices. The locating device may take advantage of this to recharge its battery via the USB port while the flash drive is connected to a USB port such as is the case when a flash drive is in use to transfer files. Alternatively, power may be supplied to recharge the battery from a dedicated charger supplied by mains power or by another source, for example, an automobile electrical system. In some embodiments, a dedicated charger connects to the locator device through the USB port; in others, separate auxiliary power connection 11 may serve this function. Auxiliary power connection 11 may be a miniature USB connector electrically coupled to USB connector 3.

Signal receiver 30 is the heart of the locator device. It is configured to receive external activating signal 6 and, having received such a signal, respond by asserting output 31. The nature of the signal receiver depends upon the nature of the activating signal.

The locator devices of the invention respond to externally generated activation signals. These signals may be generated by a variety of sources under either direct or indirect control of an operator seeking to recover a lost device. Among the modalities of activating signals suitable for use as activation signals with particular embodiments of the invention may be radio frequency electromagnetic waves (“RF”), acoustic waves, optical signals, or some combination of these. Among the activating signals that may be used are those signals, both direct and indirect, that are described in my pending U.S. patent application Ser. No. 12/156,526 filed Jun. 2, 2008 entitled Object Locator System.

As used herein, RF refers to energy transmitted as electromagnetic waves generated when an alternating current is input to an antenna. This includes frequencies assigned by regulatory agencies for wireless communication and signaling including those frequencies between about 300 Hz and about 300 GHz. As used herein, acoustic refers to energy transmitted as vibrations propagated through a medium, commonly air. This includes sonic propagation with frequency within the range of human hearing (sound), above that range (ultrasound), and below that range (infrasound). As used herein, optical refers to energy transmitted as electromagnetic waves with frequency within the range of human vision (visible light), above that range (ultraviolet light), and below that range (infrared light).

The activating signal may be tailored to the locator device with appropriate transmission modality, frequency, encoding format, and encoded information. Where the activating signal includes an RF signal, the signal receiver comprises an RF receiver. Where the activating signal includes an acoustic signal, the signal receiver comprises an acoustic receiver. Where the activating signal includes an optical signal, the signal receiver comprises an optical receiver.

In some embodiments the activating signal encodes identifying information specific to an individual locating device. In such embodiments the locator device includes a stored representation of the specific identifying information. The signal receiver determines whether there is correspondence between the stored representation of locator device identifying information and that encoded within the activating signal. If these match, signal receiver 30 asserts output 31. In some embodiments, locating device 1 may accept information for storage, such as the stored representation of locator device identifying information, from an external computer via USB port 3.

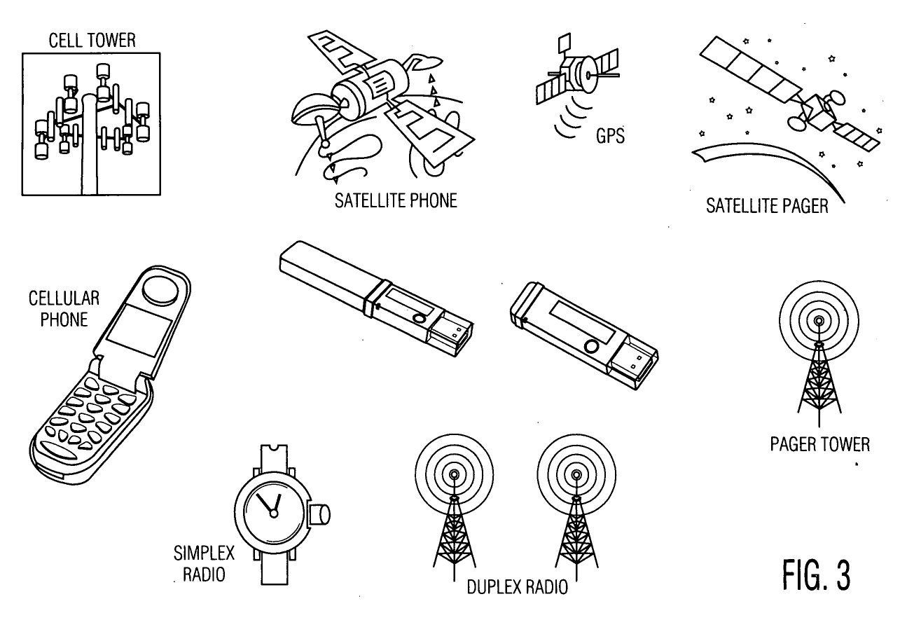

In some embodiments, activating signal 6 may be an RF signal, and may comprise cellular telephone signals, paging system signals, satellite-based telephone signals, satellite-based paging signals, simplex radio frequency signals, repeater-based duplex radio frequency signals, base station-based duplex radio frequency signals, and combinations thereof. In such embodiments, the locating device includes antenna 32 coupled to signal receiver 30. Many other choices are possible; FIG. 3 illustrates, for reference only, and without intention of limitation, some of the variety of sources that may produce activating signals. The selection of appropriate components depends upon the particular signal modality employed. For example, when the activating signal is produced by a cellular telephone system, the signal receiver would include a cellular telephone receiver. The choice of signal receiver, when an RF signal is employed, also dictates the selection of an appropriate antenna and is within the scope of an engineer skilled in the art to which this invention belongs.

Signal receiver 30 may also include controller 34 to effectuate device control operations such as comparing the received signal to the stored representation, asserting output 31, and controlling power source 37, annunciators 4 and 5, display 10, control 9, transmitter 35, and GPS receiver 36. In such embodiments controller 34 comprises a microcomputer, a single chip microcontroller, a Field Programmable Gate Array, or circuitry implementing like function.

As discussed above, when signal receiver 30 receives appropriate activating signal 6, signal receiver 30 asserts output 31. Output 31 is electrically connected to annunciator 4 or 5. Receipt of output 31 at audio annunciator 5 causes audio annunciator 5, if present, to produce sound 8 which alerts the user to the presence of the locator device. Receipt of output 31 at visual annunciator 4 causes visual annunciator 4, if present, to produce light 7 which alerts the user to the presence of the locator device. Thus the receipt of activating signal 6 causes the locator device to produce sound or light so that a user in proximity to the device may discover its presence and recover the flash drive.

Control 9 is a user-activated control present in some embodiments. It acts to deliver user input to the locator device and comprises a switch, a push button, a touch pad, or the like. Control 9 may have several functions depending on the state of the locator device (for example, whether the locator device is idle, has received an activating signal, or is connected to a USB port) and upon how the user activates control 9 (for example, by sustained contact or by intermittent contact). Among the functions of control 9 is to return the locator device to its idle state once the flash drive is recovered. Alternatively, this return to idle function may be accomplished by a timing out operation.

A second function of control 9 in some embodiments is to test the locator device by activating the annunciators.

A third function of control 9 in some embodiments is to test the charge status of the locator device battery. The locator device can display its battery status either upon display 10 or by modulating optical annunciator 4 or audio annunciator 5.

Yet another function of control 9 in some embodiments is to cause transmitter 35 to transmit a countersignal. Such a countersignal is useful to signal the activating signal source that the device has been located and that no further activation is required.

A countersignal may also serve a complementary locating function when the source of the activating signal is a cellular telephone. In embodiments where transmitter 35 comprises a cellular telephone transmitter, user activation of control 9 may trigger the device to produce a cellular telephone transmission that calls a cellular telephone. The cellular telephone number called may be pre-stored within the locating device, and is preferably entered for storage by reception of an activating signal from a cellular telephone that directly or indirectly produces the activating signal. Thus, a user may activate such an embodiment by calling the locating device from the user's cellular telephone, and at a later time locate the user's misplaced cellular telephone by activating control 9. This would cause the locator device to call back to the user's cellular telephone. The user could then locate the cellular telephone by its ringtone.

Display 10, included in some embodiments may serve to deliver a message, such as the owner's phone number, to a finder of the locating device. The message may be pre-stored in the locator device or it may be derived from information encoded in the activating signal. Display 10 presents the message upon receipt of activation signal. The activation signal may encode the message; for example, the activation signal may include a phone number that, once displayed, a finder of the device may call so that the owner may recover flash drive. Message may be pre-stored in the locator device with display triggered by receipt of the activation signal. In some embodiments, the message may be a combination of pre-stored information and information encoded in the activation signal.

Some embodiments incorporate Global Positioning System (“GPS”) receiver 36. Such embodiments have the capability of receiving positioning signals from GPS satellites and determining the actual position of the locator device. In such embodiments, upon receipt of activating signal 6, signal receiver 30 asserts output 31 causing GPS receiver 36 to calculate the actual position of the locator device, to encode the actual position as position information, and to transfer the position information to transmitter 35. Transmitter 35 then transmits the position information. A remote receiver receiving such information could then inform the user of the actual position of the locator device.

In embodiments incorporating transmitter 35 or GPS receiver 36, these components may be connected to antenna 32, or may incorporate additional antennas.

The electronic components of the invention are interconnected with each other by methods known in the art of electronic engineering. Preferably the components are attached to a printed circuit board whose traces form the electrical interconnection. The controller which forms part of the signal receiver module is preferably a single chip microcontroller, such as one of the Texas Instruments MSP430 microcontroller family. Alternatively, the controller and receiver functions may be integrated into a single device such as one of the Texas Instruments CC2510FX system on a chip devices. Functions of the controller include those stated above and may additionally include such incidental functions as monitoring the charge state of the power source, controlling the display and annunciators, monitoring whether the flash drive is connected to a computer, configuring and enabling of other components, and other functions. The limited interconnections shown between the controller and other modules in the block diagrams of FIGS. 4 and 5 are meant to merely illustrate the critical channeling of information and signals. Other connections between components, such as would normally appear on detailed schematics, are within the scope of a practitioner of ordinary skill in the art of electronic engineering.

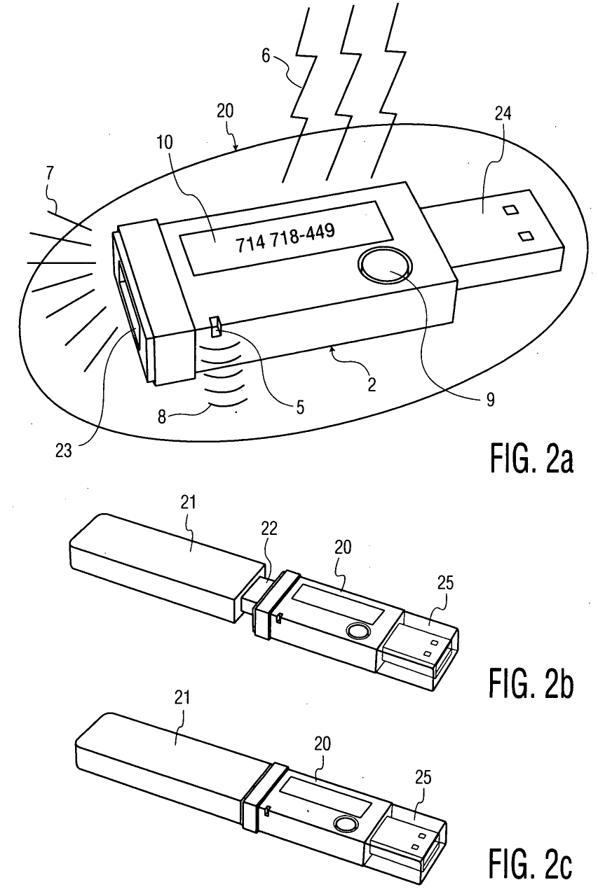

In separable embodiments of FIGS. 2 and 5, locator device 20 is separate from conventional flash drive 21 but may be coupled to flash drive 21 via the flash drive's USB connector 22 and locator device female USB connector 23. This permits transfer of the locator function between flash drives. This is valuable since the capacity of available flash drives frequently increases as manufacturers offer new models, and users find it advantageous to occasionally purchase new flash drives to take advantage of the larger capacity. Partially mated view 2b shows mating of locator device 20 and flash drive 21 through flash drive USB connector 22 and mating of protective cap 25 covering locator device male USB connector 24. The parts are shown fully mated in view 2c.

In such embodiments, locator device 20 incorporates a pair of USB connectors. These are interconnected electrically so that all signals present at the first connector are also present at the second connector. Female USB connector 23 is designed to mate with flash drive male USB connector 22. Second male USB connector 24 in locator device 20 is designed to resemble flash drive USB connector 22. In operation, a user would plug the flash drive USB connector 22 into the female USB connector 23 on locator device 20. Male USB connector 24, which may be conveniently disposed at the opposite end of elongated housing 2 from female USB connector 23, is available to plug the combination flash drive and locator assembly into a computer or other female USB port. The feed through of the electrical signals from the second connector to the first ensures that the flash drive receives the same signals when the combination assembly is plugged into computer USB port as a stand alone flash drive would have received had it been plugged directly into the computer USB port. Each of the other features and components of unitized embodiment 1 as described above may also be present in separable embodiment 20 with the exception of flash memory 39.

Since mating USB connectors are designed to be separable from one another, a user might inadvertently separate flash drive 21 from the flash drive-locator device assembly when removing the assembly from a computer USB port. In some embodiments, the locator device is designed so that female USB connector 23 fits more snuggly with standard USB male connector 22 on flash drive 21 than does male USB connector 20 with a computer's standard USB female connector. This reduces the likelihood of separation of the assembly were a user to grip it by holding only flash drive 21. This more snug fit may be accomplished through the use of nonstandard USB connectors on locator device 20. It may also be accomplished through the use of standard USB connectors modified by inclusion of relatively high friction material in the mating region.

In the Summary of the Invention and in the Detailed Description, reference is made to particular features of the invention. It is to be understood that the disclosure of the invention in this specification includes all appropriate combinations of such particular features. For example, where a particular feature is disclosed in the context of a particular aspect or embodiment of the invention, that feature can also be used, to the extent appropriate, in combination with and/or in the context of other particular aspects and embodiments of the invention, and in the invention generally.

In describing and claiming the invention below, the term “comprises” (and grammatical variations thereof) in relation to features, components, modalities, things, etc. is used herein to mean that the features, components, modalities, things, etc. can optionally include, in addition to the features, components, modalities, things, etc. explicitly specified after the term “comprises” (and grammatical variations thereof), other features, components, modalities, things, etc. It is to be understood that the above described arrangements are mere illustrative of the application of the principles of the invention and that numerous other arrangements may be devised by those skilled in the art to which this invention belongs, and particularly in the art of electronic engineering, without departing from the spirit and scope of the invention.

I claim:

1. A locating memory device indicating its presence in response to an external signal, the device comprising:
a housing;
a USB connector disposed within the housing;
a flash memory drive disposed within the housing and electrically coupled to the USB connector;
a signal receiver disposed within the housing and capable of generating an output in response to the external signal;
a power source disposed within the housing electrically coupled to the USB connector and to the signal receiver; and
an annunciator coupled to the signal receiver and capable of signaling the presence in response to the output.

2. The locating memory device of claim 1 wherein the power source comprises a rechargeable battery and a charging circuit electrically coupled to the rechargeable battery and to the USB connector and configured to deliver energy to the rechargeable battery when an electrical potential is present at the USB connector.

3. The locating memory device of claim 1 wherein the power source comprises a rechargeable battery and a charging circuit electrically coupled to the rechargeable battery configured to receive energy from an automobile electrical system.

4. The locating memory device of claim 1 wherein the annunciator includes at least one of an audio transducer, a light source, and a flashing light source.

5. The locating memory device of claim 1 wherein the signal receiver comprises an RF antenna, an RF receiver operatively coupled to the RF antenna, and a controller operatively coupled to the RF receiver.

6. The locating memory device of claim 1 further comprising a control disposed within the housing and a transmitter operatively connected to the control and configured to transmit a countersignal in response to user activation of the control.

7. The locating device of claim 6 wherein the activating signal comprises a a phone signal sourced by a cellular telephone and and wherein the transmitter comprises a cellular telephone transmitter and wherein the countersignal comprises a cellular telephone transmission.

8. The locating device of claim 7 wherein the countersignal is directed to the source of the phone signal.

9. The locating memory device of claim 5 further comprising a display disposed within the housing, operatively coupled to the controller, and configured to display a message in response to the output.

10. The locating memory device of claim 1 wherein the activating signal is selected from a group consisting of electromagnetic signals, acoustic signals, optical signals, and a combination thereof

11. The locating memory device of claim 10 wherein the electromagnetic signals comprise radio frequency electromagnetic waves selected from a group consisting of cellular telephone signals, paging system signals, satellite-based telephone signals, satellite-based paging signals, simplex radio frequency signals, repeater-based duplex radio frequency signals, base station-based duplex radio frequency signals, and a combination thereof.

12. The locating memory device of claim 1 further comprising:
a transmitter disposed within the housing;
a GPS receiver disposed within the housing and operatively connected to the transmitter and to the signal receiver,
wherein the GPS receiver is configured to receive GPS signals and to calculate the position of the locating memory device and to encode the position as position information in response to the output and to transfer the position information to the transmitter, and
wherein the transmitter is configured to transmit the position information.

13. A locating device indicating its presence in response to an external signal, the device comprising:
a housing;
a male USB connector disposed within the housing;
a female USB connector disposed within the housing and electrically coupled to the male USB connector;
a signal receiver disposed within the housing and capable of generating an output in response to the external signal;
a power source disposed within the housing and electrically coupled to the signal receiver; and
an annunciator coupled to the signal receiver and capable of indicating the presence of the locating device in response to the output.

14. The locating device of claim 13 wherein the female USB connector mates with a standard USB male connector with greater retentive force than does the male USB connector with a standard USB female connector.

15. The locating device of claim 13 wherein the power source comprises a rechargeable battery electrically coupled to the male USB connector.

16. The locating device of claim 13 wherein the annunciator includes at least one of an audio transducer, a light source, and a flashing light source.

17. The locating device of claim 13 wherein the signal receiver includes at least one of an RF receiver, an acoustic receiver, and an optical receiver.

18. The locating device of claim 13 further comprising a display disposed within the housing, operatively coupled to the signal receiver, and configured to display a message in response to the output.

19. The locating device of claim 13 further comprising a transmitter disposed within the housing.

20. The locating device of claim 19 further comprising a control disposed within the housing, wherein the transmitter is operatively connected to the control, and is configured to transmit a countersignal in response to user activation of the control.

21. The locating device of claim 20 wherein the activating signal comprises a phone signal sourced by a cellular telephone and wherein the transmitter comprises a cellular telephone transmitter and wherein the countersignal comprises a cellular telephone transmission.

22. The locating device of claim 21 wherein the countersignal is directed at the source of the phone signal.

23. The locating device of claim 19 further comprising:
a GPS receiver disposed within the housing and operatively connected to the transmitter and to the signal receiver, wherein the GPS receiver is configured to receive GPS signals and to calculate the position of the locating device and to encode the position as position information in response to the output and to transfer the position information to the transmitter, and wherein the transmitter is configured to transmit the position information.

24. A locating device indicating its presence in response to an external RF signal, the device comprising:
a housing comprising a male USB connector and a female USB connector electrically coupled to the male USB connector wherein the female USB connector mates with a standard USB male connector with greater retentive force than does the male USB connector with a standard USB female connector;
a RF antenna disposed within the housing and capable of collecting the RF signal;
an RF receiver disposed within the housing, coupled to the RF antenna, and capable of generating an output in response to the collected RF signal;
a rechargeable battery disposed within the housing and electrically coupled to the male USB connector;
a light source operatively coupled to the RF receiver and configured to flash in response to the output; and
an audio transducer operatively coupled to the RF receiver and configured to produce an audible signal in response to the output.
